(19) United States
(12) Patent Application Publication
(10) Pub. No.: US 2004/0091741 A1
(43) Pub. Date: May 13, 2004

(54) Organic electroluminescent device and method for manufacturing the same

(76) Inventors: Hsien-Chang Lin, Jubei City (TW); Chii-Feng Chiu, Taoyuan (TW); Shen-Shen Wang, Junghe City (TW); Shih-Shin Liang, Chiai (TW)

Correspondence Address: BIRCH STEWART KOLASCH & BIRCH, PO BOX 747, FALLS CHURCH, VA, 22040-0747, US

(21) Appl. No.: 10/691,597

(22) Filed: Oct. 24, 2003

(30) Foreign Application Priority Data
Oct. 25, 2002 (TW) 091125336
Oct. 25, 2002 (TW) 091125335
Oct. 25, 2002 (TW) 091125334

(51) Int. Cl. B32B 9/00

(52) U.S. Cl. 428/690

(57) ABSTRACT

A method for forming a drying film of an organic electroluminescent device includes the steps of: providing a desiccant, and depositing the desiccant to form the drying film. The drying film is formed on a lid of the organic electroluminescent device or over a substrate thereof. Furthermore, an organic electroluminescent device is also disclosed. The organic electroluminescent device includes a substrate, a first electrode, an organic functional layer, a second electrode, a lid or passivation film, and a drying film. The substrate and the lid or passivation layer form an airtight space, in which the first electrode, organic functional layer and second electrode are located. In such cases, the drying film is formed with a deposition method.

### BACKGROUND OF THE INVENTION

1. Field of Invention

The invention relates to an organic electroluminescent device and, in particular, to an organic electroluminescent device having a drying film.

2. Related Art

Accompanying the developing of high technology, the present electrical devices become more compact, and the materials for manufacturing the electrical devices differ from those used in prior. These materials may be sensitive to moisture and oxygen of the environment. In other words, these materials and moisture or oxygen may have chemical reactions or physical reactions, resulting in degradations of the materials and malfunctions of the electrical device.

An organic electroluminescent device, which is one of the most popular flat displays, employs organic functional materials with self-emitting characteristic to achieve the object of displaying. With reference to FIG. 1, an organic electroluminescent device 1 includes a substrate 11, a first electrode 12, an organic functional layer 13, a second electrode 14, and a lid 15. In this case, the substrate 11 and the first electrode 12 are transparent, and the organic functional layer 13 is sandwiched between the first and second electrodes 12, 14. The first electrode 12 and second electrode 14 are used as an anode and a cathode respectively. When the first and second electrodes 12, 14 are charged with a current or voltage, electrons and holes move and recombine in the organic functional layer 13 to generate excitons. The organic functional layer can then radiate light of different colors according to The organic functional layer can then radiate light of different colors according to their properties.

The failure mechanism of the conventional organic electroluminescent device is usually caused by dark spots of the device. Thus, it is an important subjective to reduce the formation of dark spots for enhancing the durability of the organic electroluminescent device. Since the organic functional layer or second electrode may react with moisture (or oxygen) causing the formation of dark spots, it is important to remove moisture completely. Consequently, the layers of the organic electroluminescent device are usually formed in vacuum, and the organic electroluminescent device is then encapsulated under normal pressure. This method, however, cannot totally prevent the organic electroluminescent device from being damaged by moisture, and the dark spots are still obtained. Furthermore, the vacuum for forming layers of the organic electroluminescent device and the normal pressure for encapsulation are quite different, so that the whole manufacturing processes are complicated, the production yield is decreased and the manufacturing cost is increased. Moreover, before the encapsulation, the moisture or oxygen may enter the organic electroluminescent device, resulting in the degradation of the device.

To prevent the formation of dark spots, the residual moisture inside the organic electroluminescent device should be removed. It is a common method to provide a water-trapping agent or drying agent inside the organic electroluminescent device. There are several related granted patents and applications. For example, EP0776147 discloses an airtight container for airtightly containing the organic functional layer to isolate it from the external atmosphere, and a drying substance airtightly contained in the airtight container for absorbing moisture. The drying substance can be calcium oxide and barium oxide. In GB2368192, an organometallic compound is used as a drying member to prevent contamination of the organic electroluminescent device from moisture. The organometallic compound adsorbs water and roles as an adhering agent for other physical drying agents and chemical drying agents and has no adverse effect on the organic electroluminescent device and can prevent growth of dark spots. U.S. Pat. No. 6,226,890 discloses a binder having good water vapor permeability rate to maintain or enhance the moisture absorption rate of the desiccant and to blend the desiccant therein. The binder is in liquid phase or dissolved in a liquid, and is then solidified to form a desiccant layer inside the organic electroluminescent device.

In more details, there are two methods to form the drying substance or desiccant inside the organic electroluminescent device. Referring to FIG. 2A, firstly, a desiccant 26 is loaded into a preformed cavity 251 of a lid 25, and a permeable film 27 is then formed on the cavity 251. As shown in FIG. 2B, the lid 25 with the desiccant 26 is placed on the substrate, on which a first electrode, an organic functional layer and a second electrode are formed. The lid 25 and the substrate 21 are encapsulated with a seal 252 to form an airtight space. In this case, since the desiccant 26 is positioned in the cavity 251 and the permeable film 27 is necessary, the manufacturing processes of the organic electroluminescent device become more complicated. Thus, the production yield is decreased and the manufacturing cost is increased.

With reference to FIG. 3A, the desiccant 36 is blended in the solution containing a permeable polymer, and the solution is then dispensed on the lid 35 to form a drying film 37 including the desiccant 36. The solvent is then removed away. After that, the lid 35 is stacked on the substrate 31 having a first electrode 32, an organic functional layer 33, and a second electrode 34. As shown in FIG. 3B, the lid 35 and the substrate 31 are encapsulated with a seal 351 to form an airtight space. The first electrode 32, organic functional layer 33, second electrode 34, drying film 37, and desiccant 36 are located in the airtight space. In this method, a solidification process is necessary to heat the solution and remove the solvent away. There is, however, some residual solvent left in the organic electroluminescent device, resulting in the degradation of the seal 351. Thus, the peeling-off of the substrate 31 and lid 35 occurs, and the device is then damaged.

As mentioned above, the desiccant is dispensed on the lid and the polymer solution is used as a bonding agent to fix the desiccant inside the organic electroluminescent device to obtain a drying layer. This dispensing process cannot be integrated with the vacuum deposition processes for forming the organic functional layer and second electrode. As previously described, since the vacuum and normal pressure are necessary, the manufacturing processes is complicated, the production yield is decreased, and the cost is increased. Furthermore, the drying layer formed by the dispensing process may have pin holes, and the drying layer may not be formed perfectly.

When utilizing the bonding agent to fix the desiccant, the thickness of the drying layer cannot be reduced efficiently. Thus, the minimization of the organic electroluminescent device is limited. Theoretically, the organic electroluminescent device has simple structure, and is thinner than other flat panel displays such as an LCD. The required drying layer, however, increases the thickness of the organic electroluminescent device, so that the advantage of the organic electroluminescent device having thinner thickness is sacrificed. Moreover, when utilizing the bonding agent to fix the desiccant, only part of the desiccant located at the surface of the drying layer can absorb the moisture within the organic electroluminescent device. Therefore, the absorption ability of the desiccant suffers.

Therefore, it is important to provide a method for forming the drying layer, which can integrate the deposition environment when forming the organic functional layer, second electrode and drying layer, and prevent the elements of the organic electroluminescent device from exposing in atmosphere before the encapsulation process. Furthermore, it is also important to provide an organic electroluminescent device and method for manufacturing the same, which can integrate the deposition environments when forming the organic functional layer, second electrode and drying layer, reduce the thickness of the drying layer, and enhance the absorption ability of the drying layer.

### SUMMARY OF THE INVENTION

In view of the above-mentioned problems, an objective of the invention is to provide a method for forming a drying film, which can decrease the thickness of the drying film, enhance the absorption ability of the drying film, and integrate the deposition environments when forming the organic functional layer, second electrode and drying layer to prevent the elements of the organic electroluminescent device from exposing in atmosphere before an encapsulation process.

It is another objective of the invention to provide an organic electroluminescent device and method for manufacturing the same, which can decrease the thickness of the drying film, enhance the absorption ability of the drying film, and integrate the deposition environments when forming the organic functional layer, second electrode and drying layer to prevent the elements of the organic electroluminescent device from exposing in atmosphere before an encapsulation process.

To achieve the above-mentioned objectives, a method for forming a drying film of the invention includes providing a desiccant, and forming the drying film from the desiccant with a deposition method. The method for forming a drying film is used to form a drying film of an organic electroluminescent device. The drying film is formed on a lid or over a substrate of the organic electroluminescent device.

The invention further discloses an organic electroluminescent device, including a substrate, a first electrode, an organic functional layer, a second electrode, a drying film, and a lid. In the invention, the first electrode is disposed on the substrate, the organic functional layer is disposed on the first electrode, and the second electrode is disposed on the organic functional layer. The lid is disposed over the second electrode, and the substrate and lid form an airtight space for containing the first electrode, organic functional layer, second electrode, and drying film. The drying film is formed with a deposition method.

The invention also discloses a method for manufacturing an organic electroluminescent device. The method includes providing a substrate, forming a first electrode on the first substrate, forming an organic functional layer on the first electrode, forming a second electrode on the organic functional layer, providing a lid, depositing a drying film on the lid or over the substrate, and providing the lid on the substrate to form an airtight space. In the invention, the first electrode, the organic functional layer, the second electrode, and the drying film are encapsulated in the airtight space.

An additional organic electroluminescent device of the invention includes a substrate, a first electrode, an organic functional layer, a second electrode, a drying film, and a passivation film. In this aspect, the first electrode is disposed on the substrate, the organic functional layer is disposed on the first electrode, and the second electrode is disposed on the organic functional layer. The drying film is disposed over the substrate with a deposition method. The passivation film is disposed over the substrate, and the passivation film and the substrate form an airtight space. The first electrode, the organic functional layer, the second electrode, and the drying film are located in the airtight space.

An additional method for manufacturing an organic electroluminescent device includes providing a substrate, forming a first electrode on the substrate, forming an organic functional layer on the first electrode, forming a second electrode on the organic functional layer, depositing a drying film over the substrate, and forming a passivation film over the substrate. In this aspect, the passivation film and the substrate form an airtight space, in which the first electrode, the organic functional layer, the second electrode, and the drying film are located.

Since the drying film of the invention is formed with a deposition method, the deposition environments for forming the organic functional layer, second electrode and drying layer can be integrated to decrease the manufacturing cost. Furthermore, the elements of the organic electroluminescent device would not be exposed in atmosphere before the encapsulation process, so that the production yield of the organic electroluminescent device is increased. Because the invention utilizes a deposition method to form the drying film, the bonding agent causing the residual solvent is avoided. Moreover, the invention can also reduce the thickness of the drying film, and enhance the absorption ability of the drying film.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing a conventional organic electroluminescent device;

FIG. 2A is a schematic illustration showing a lid and a desiccant of a conventional organic electroluminescent device;

FIG. 2B is a schematic illustration showing a conventional organic electroluminescent device having the lid and desiccant as shown in FIG. 2A;

FIG. 3A is a schematic illustration showing a lid and a desiccant of an additional conventional organic electroluminescent device;

FIG. 3B is a schematic illustration showing an additional conventional organic electroluminescent device having the lid and desiccant as shown in FIG. 3A;

FIGS. 4A to 4D are schematic illustrations showing an organic electroluminescent device according to a preferred embodiment of the invention, wherein the drying film is formed at different position;

FIGS. 5A to 5B are schematic illustrations showing an organic electroluminescent device according to an additional embodiment of the invention, wherein the drying film is formed at different position;

FIG. 6 is a flow chart showing a method for forming a drying film according to a preferred embodiment of the invention;

FIG. 7 is a schematic illustration showing a drying film deposited on a lid utilizing the method for forming a drying film according to the preferred embodiment of the invention;

FIG. 8 is a schematic illustration showing a drying film deposited over a substrate formed with a first electrode, an organic functional layer, and a second electrode utilizing the method for forming a drying film according to the preferred embodiment of the invention;

FIG. 9 is a flow chart showing a method for manufacturing an organic electroluminescent device according to a preferred embodiment of the invention, wherein the organic electroluminescent device includes a lid; and

FIG. 10 is a flow chart showing a method for manufacturing an organic electroluminescent device according to an additional embodiment of the invention, wherein the organic electroluminescent device includes a passivation film.

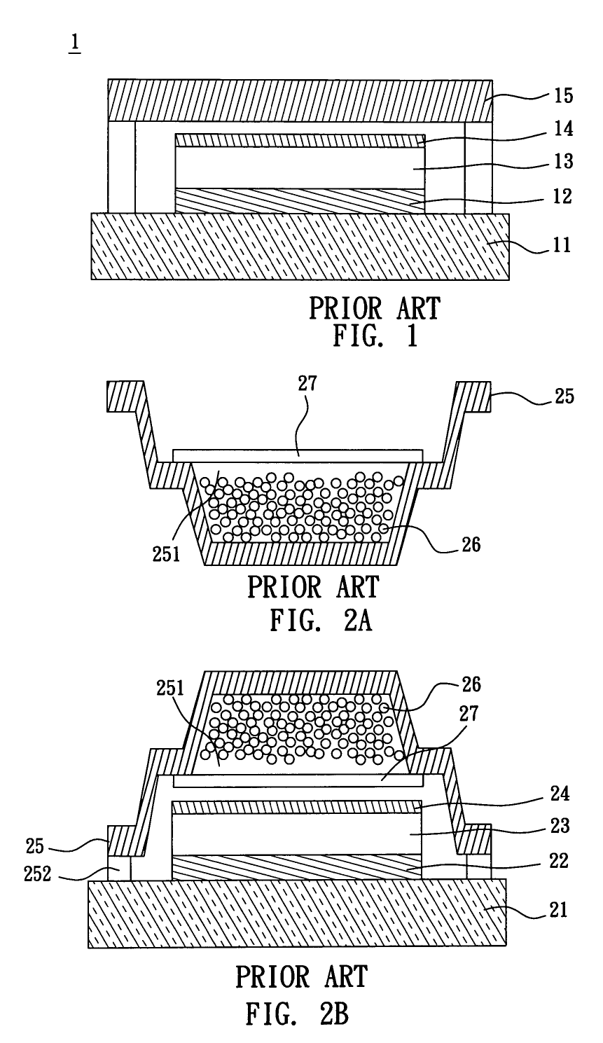

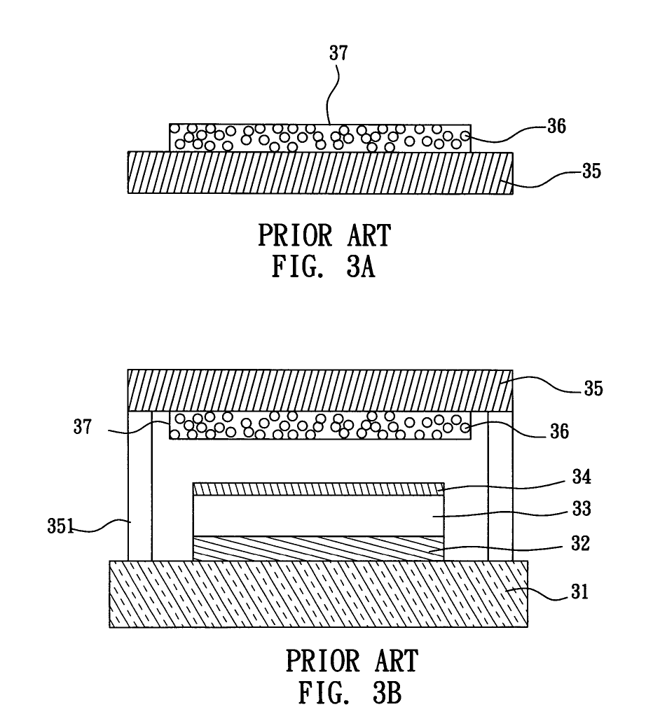

### DETAILED DESCRIPTION OF THE INVENTION

The method for forming a drying film, organic electroluminescent device, and method for manufacturing the device according to preferred embodiments of the invention will be described herein below with reference to the accompanying drawings, wherein the same reference numbers refer to the same elements.

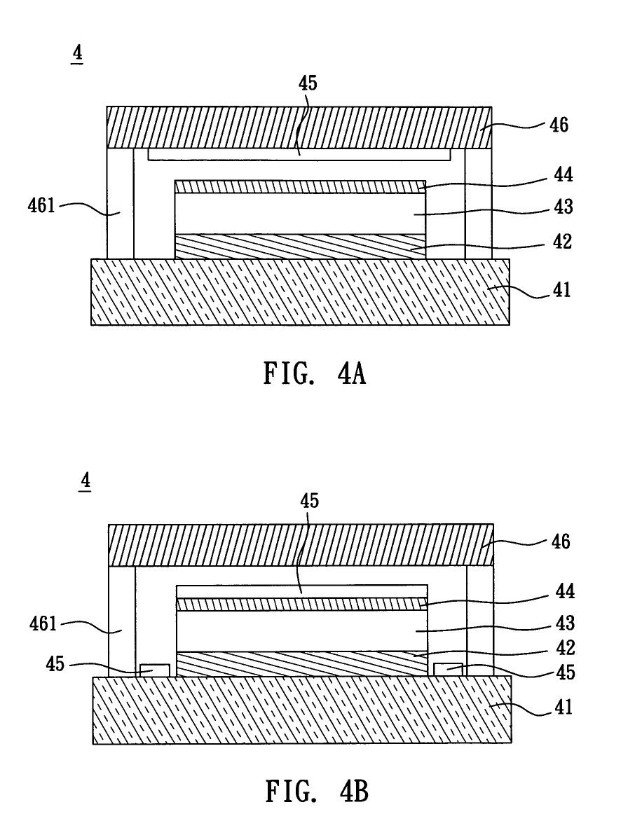

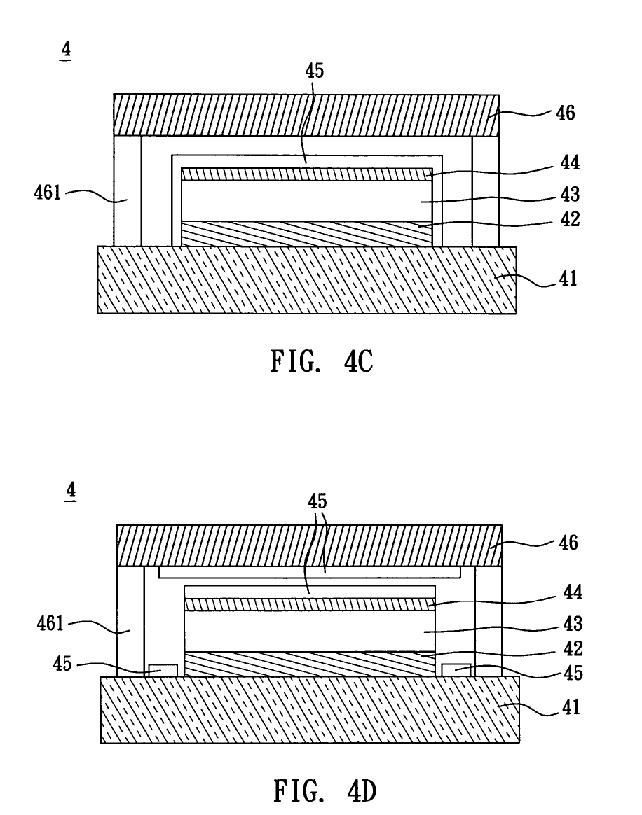

With reference to FIG. 4A, an organic electroluminescent device 4 according to an embodiment of the invention includes a substrate 41, a first electrode 42, an organic functional layer 43, a second electrode 44, a drying film 45, and a lid 46.

The first electrode 42 is disposed on the substrate 41, the organic functional layer 43 is disposed on the first electrode 42, and the second electrode 44 is disposed on the organic functional layer 43. The lid 46 is disposed over the second electrode 44, and the drying film 46 is disposed on a surface of the lid 46 facing to the second electrode 44.

In the current embodiment, the substrate 41 is usually a transparent substrate such as a glass substrate, a plastic substrate, or a flexible substrate. In particular, the flexible substrate or plastic substrate can be made of polycarbonate (PC), polyester (PET), cyclic olefin copolymer (COC), metallocene-based cyclic olefin copolymer (mCOC), or thin glass.

The first electrode 42 is disposed on the substrate 41 by sputtering or ion plating. The first electrode 42 is usually used as an anode and made of a transparent conductive metal oxide, such as indium-tin oxide (ITO), aluminum-zinc oxide (AZO), or indium-zinc oxide (IZO).

The organic functional layer 43 of the current embodiment is disposed on the first electrode 42. The organic functional layer 43 usually contains a hole injection layer, a hole transporting layer, a light-emitting layer, an electron transporting layer, and an electron injection layer (not shown). For example, the hole injection layer is mainly composed of copper phthalocyanine (Cupc), the hole transporting layer is mainly composed of 4,4′-bis[N-(1-naphthyl)-N-phenylamino]biphenyl (NPB), the electron injection layer is mainly composed of lithium fluoride (LiF), and the electron transporting layer is mainly composed of tris(8-quinolinato-N1,08)-aluminum (Alq). Each layer of the organic functional layer 43 can be disposed on the first electrode 42 by evaporation, spin coating, ink jet printing, or printing. In addition, the light emitted from the organic functional layer 43 can be blue, green, red, white or other monochromatic light, or color light.

The second electrode 44 is typically used as a cathode and is disposed on the organic functional layer 43 by evaporation or sputtering. The material of the second electrode 44 can be aluminum, calcium, or magnesium-silver alloys. The material of the second electrode 44 can also be aluminum/lithium fluoride, or silver.

The lid 46 is provided on the substrate 41 with a seal 461, which surrounds the first electrode 42, organic functional layer 43, and second electrode 44. The lid 46 and the substrate 41 constructs an airtight space for isolating the first electrode 42, organic functional layer 43, second electrode 44 and drying film 45 from the external atmosphere to prevent from being damaged by moisture or oxygen.

The drying film 45 is formed with a deposition method, such as a vapor deposition method, a physical vapor deposition method, a chemical vapor deposition method, or an evaporation method. In the present embodiment, the drying film 45 is made of deposition source materials. For example, the material of the drying film 45 is at least one selected from the group consisting of an organometallic complex compound, an alkaline metal compound, an alkaline metal oxide compound, an alkaline earth metal compound, an alkaline earth metal oxide compound, a sulfate compound, a metal halide compound, a perchlorate compound, or an organic compound.

In addition, the drying film 45 can be deposited on the second electrode 44 or the substrate 41. Referring to FIG. 4B, in another embodiment of the invention, the drying film 45 is deposited on the second electrode 44 and the substrate 41 surrounding the first electrode 42. As shown in FIG. 4C, the drying film 45 encapsulates the first electrode 42, organic functional layer 43 and second electrode 44. Those skilled in the art should know that the above-mentioned characters could be applied in a single embodiment. For example, the drying film 45 can be deposited on the lid 46, second electrode 44 and substrate 41 (as shown in FIG. 4D).

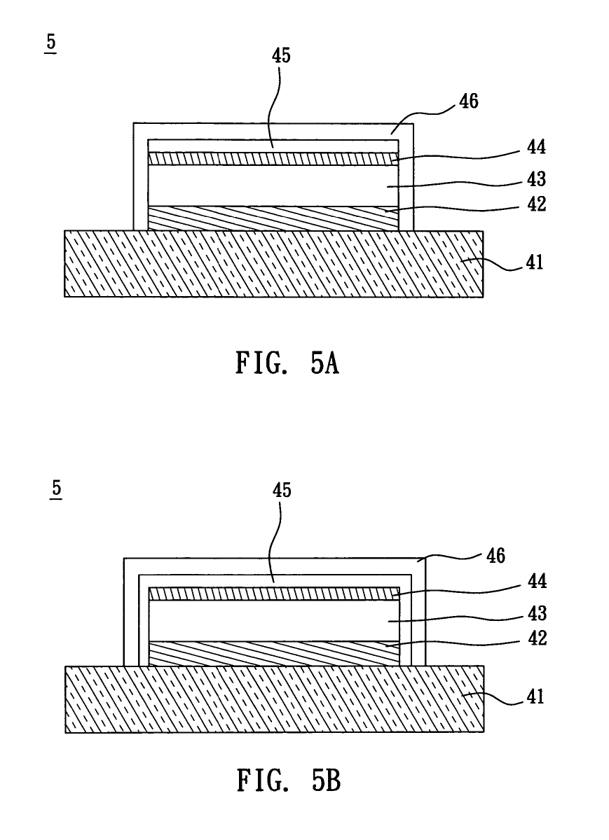

With reference to FIG. 5A, an organic electroluminescent device 5 according to an additional embodiment of the invention includes a substrate 41, a first electrode 42, an organic functional layer 43, a second electrode 44, a drying film 45, and a passivation layer 47.

As shown in FIG. 5, the first electrode 42 is formed on the substrate 41, the organic functional layer 43 is formed on the first electrode 42, the second electrode 44 is formed on the organic functional layer 43, and the drying film 45 is formed on the second electrode 44. The passivation film 47 encapsulates the first electrode 42, organic functional layer 43, second electrode 44, and drying film 45.

In this embodiment, the passivation layer 47 is a non-permeable film, and is formed with a deposition method. The passivation film 47 can be made of silicon oxide, silicon nitride, or silicon oxide nitride. Alternatively, the passivation film 47 can be formed with a dispensing method, and is dispensed to encapsulate the first electrode 42, organic functional layer 43, second electrode 44, and drying film 45. Furthermore, the passivation film 47 can be a preformed thin film, and is attached to the substrate 41 to encapsulate the first electrode 42, organic functional layer 43, second electrode 44, and drying film 45. The passivation film 47 can be made of epoxy resin. As shown in FIG. 5A, the passivation film 47 and substrate 41 construct an airtight space for isolating the first electrode 42, organic functional layer 43, second electrode 44 and drying film 45 from the external atmosphere to prevent from erosion of moisture or oxygen.

The drying film 45 can be deposited around the first electrode 42, organic functional layer 43, and second electrode 44. With reference to FIG. 5B, in an organic electroluminescent device 5 according to an additional embodiment of the invention, the drying film 45 encapsulates the first electrode 41, organic functional layer 43, and second electrode 44, and the passivation film 47 is formed on the drying film 45.

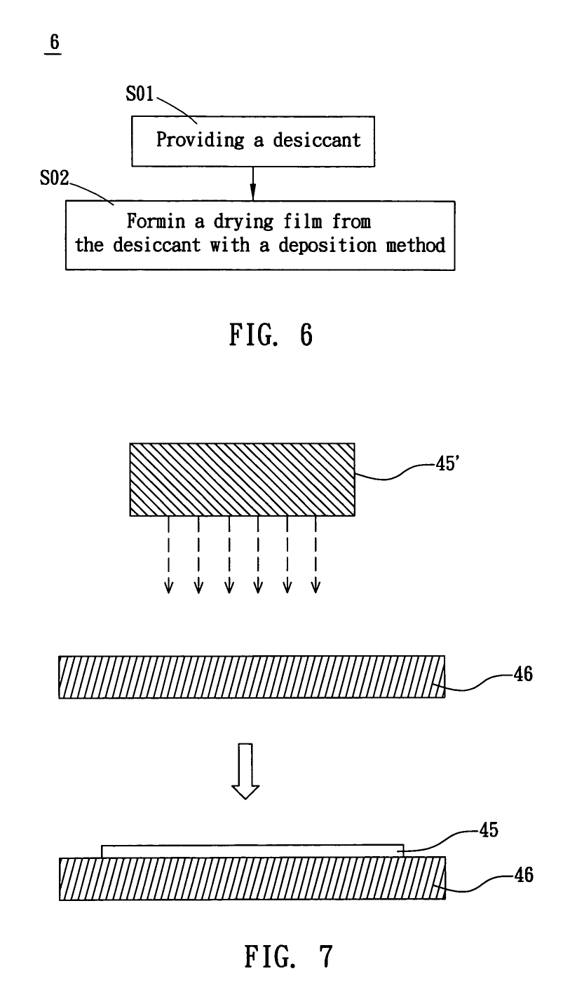

The invention also discloses a method for forming a drying film. With reference to FIG. 6, the method for forming a drying film according to a preferred embodiment of the invention includes the steps S01 to S02.

First, the step S01 provides a desiccant. In the embodiment, the desiccant is consisting of a deposition source material. In other wards, the material of the desiccant can be applied in a deposition process and have moisture absorption ability. The desiccant is at least one selected from the group consisting of an organometallic complex compound, an alkaline metal compound, an alkaline metal oxide compound, an alkaline earth metal compound, an alkaline earth metal oxide compound, a sulfate compound, a metal halide compound, a perchlorate compound, or an organic compound.

In step S02, a drying film is formed from the desiccant with a deposition method. In the embodiment, the drying film can be formed with any conventional deposition method, such as a vapor deposition method, a physical vapor deposition method, a chemical vapor deposition method, or an evaporation method, with using the desiccant as a deposition source.

Two applications of the method for forming a drying film of the invention are described herein below. Referring to FIG. 7, the method for forming a drying film of the invention is performed on a lid 46. In this embodiment, the lid 46 is used to encapsulate a preformed organic electroluminescent device (as shown in FIG. 4A). The performed organic electroluminescent device includes the substrate 41, the first electrode 42, the organic functional layer 43, and the second electrode 44. With reference to FIG. 7, the deposition source 45′ is the previously mentioned desiccant. A deposition process is performed to deposit the deposition source 45′ onto the lid 46 so as to form the drying film 45.

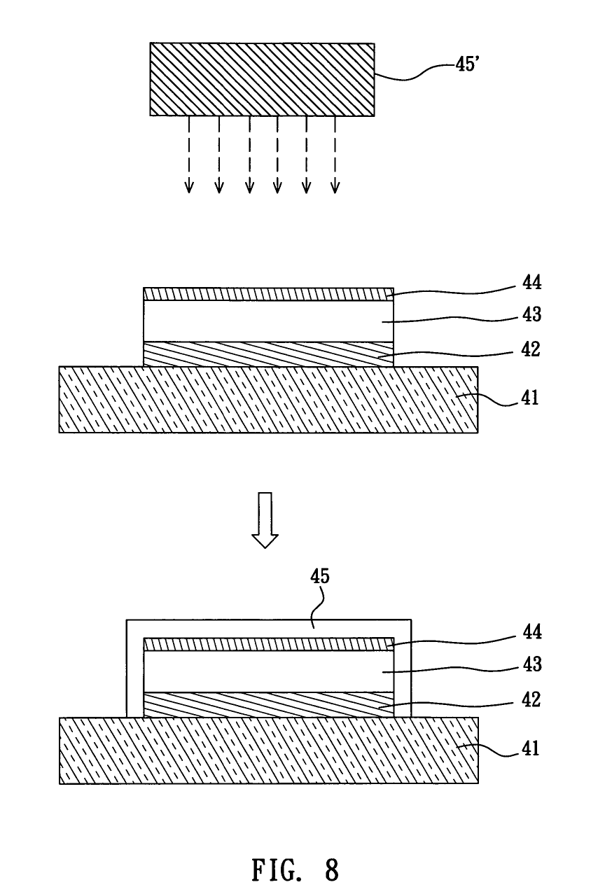

Referring to FIG. 8, the method for forming a drying film of the invention can be performed on a preformed organic electroluminescent device. In this embodiment, the performed organic electroluminescent device includes the substrate 41, the first electrode 42, the organic functional layer 43, and the second electrode 44. With reference to FIG. 8, the deposition source 45′ is the previously mentioned desiccant. A deposition process is performed to deposit the deposition source 45′ on the preformed organic electroluminescent device so as to form the drying film 45. It should be noted that the drying film 45 may encapsulate the first electrode 42, organic functional layer 43, and second electrode 44. Alternatively, the drying film 45 may be formed on the second electrode 44 only.

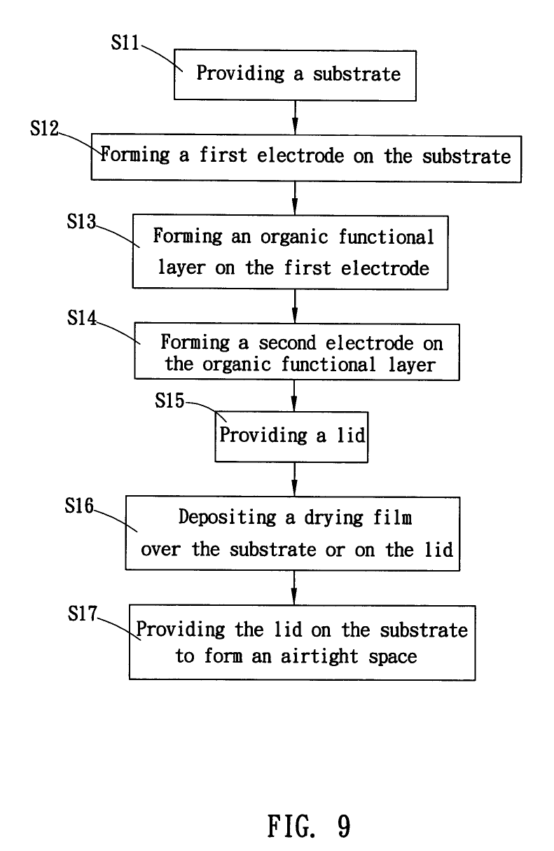

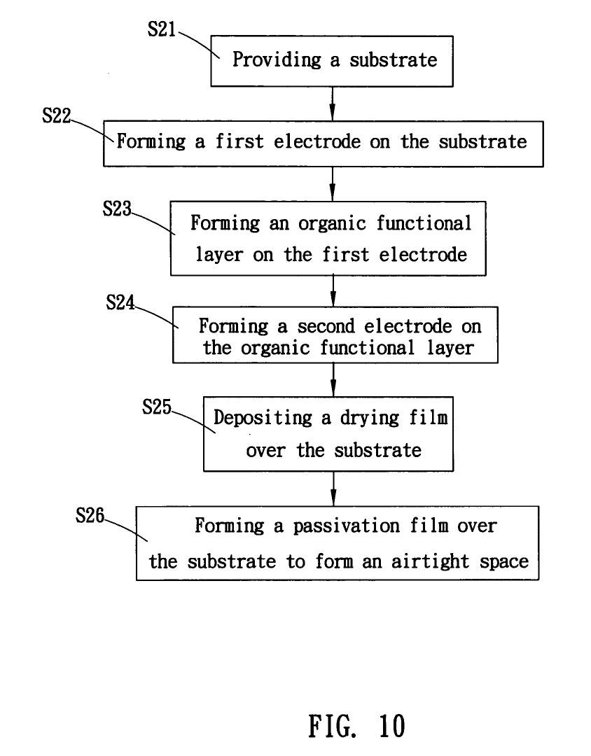

An encapsulation process is then performed to complete the entire organic electroluminescent device. The whole flow of the method for manufacturing an organic electroluminescent device of the invention is described herein below with reference to FIG. 9 and FIG. 10. Referring to FIG. 9, the method for manufacturing an organic electroluminescent device according to an embodiment of the invention includes providing a substrate (S11), forming a first electrode on the substrate (S12), forming an organic functional layer on the first electrode (S13), forming a second electrode on the organic functional layer (S14), providing a lid (S15), depositing a drying film over the substrate or on the lid (S16), and providing the lid on the substrate to form an airtight space (S17). In this embodiment, the first electrode, the organic functional layer, the second electrode, and the drying film are encapsulated in the airtight space.

Referring to FIG. 10, the method for manufacturing an organic electroluminescent device according to an additional embodiment of the invention includes providing a substrate (S21), forming a first electrode on the substrate (S22), forming an organic functional layer on the first electrode (S23), forming a second electrode on the organic functional layer (S24), depositing a drying film over the substrate (S25), and forming a passivation film over the substrate to form an airtight space (S26). In this embodiment, the first electrode, the organic functional layer, the second electrode, and the drying film are encapsulated in the airtight space.

Since the invention utilizes a deposition method to form the drying film, the deposition environments for forming the organic functional layer, second electrode and drying layer can be integrated. Therefore, the machines for performing the conventional dispensing, coating and ink-jet printing process are unnecessary, and the manufacturing cost is reduced. Furthermore, the elements of the organic electroluminescent device would not be exposed in atmosphere before the encapsulation process, so that the production yield of the organic electroluminescent device is increased. The drying film is formed with a deposition method in the invention, so that the conventional bonding agent causing the residual solvent is avoided. Moreover, the thickness of the drying film is decreased, and the absorption ability of the drying film is enhanced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An organic electroluminescent device, comprising:
a substrate;
a first electrode disposed on the substrate;
an organic functional layer disposed on the first electrode;
a second electrode disposed on the organic functional layer;
a lid disposed over the substrate, wherein the lid and the substrate form an airtight space, and the first electrode, the organic functional layer, and the second electrode are located in the airtight space; and
a drying film deposited in the airtight space.

2. The device of claim 1, wherein the drying film is deposited on a surface of the lid, on the second electrode, or caps the first electrode, the organic functional layer, and the second electrode.

3. The device of claim 1, wherein the drying film is made of a deposition source.

4. The device of claim 3, wherein the deposition source is a desiccant material and is selected from the group consisting of an organometallic complex compound, an alkaline metal compound, an alkaline metal oxide compound, an alkaline earth metal compound, an alkaline earth metal oxide compound, a sulfate compound, a metal halide compound, a perchlorate compound, and an organic compound.

5. A method for manufacturing an organic electroluminescent device, comprising: providing a substrate;
providing a lid;
forming a first electrode on the substrate;
forming an organic functional layer on the first electrode;
forming a second electrode on the organic functional layer;
depositing a drying film over the substrate or on the lid; and
providing the lid on the substrate to form an airtight space, wherein the first electrode, the organic functional layer, the second electrode, and the drying film are encapsulated in the airtight space.

6. The method of claim 5, wherein the drying film is deposited on the second electrode, or caps the first electrode, the organic functional layer, and the second electrode.

7. The method of claim 5, wherein the drying film is deposited on a surface of the lid, and the surface formed with the drying film faces to the second electrode.

8. The method of claim 5, wherein the drying film is formed with a vapor deposition method.

9. The method of claim 8, wherein the drying film is form with a physical vapor deposition method, a chemical vapor deposition method, or an evaporation method.

10. The method of claim 5, wherein the drying film is made of a deposition source.

11. The method of claim 10, wherein the deposition source is a desiccant material and is selected from the group consisting of an organometallic complex compound, an alkaline metal compound, an alkaline metal oxide compound, an alkaline earth metal compound, an alkaline earth metal oxide compound, a sulfate compound, a metal halide compound, a perchlorate compound, and an organic compound.

12. An organic electroluminescent device, comprising:
a substrate;
a first electrode disposed on the substrate;
an organic functional layer disposed on the first electrode;
a second electrode disposed on the organic functional layer;
a drying film deposited over the substrate; and
a passivation film disposed over the substrate, wherein the passivation film and the substrate form an airtight space, and the first electrode, the organic functional layer, the second electrode, and the drying film are located in the airtight space.

13. The device of claim 12, wherein the drying film is deposited on the second electrode or caps the first electrode, the organic functional layer, and the second electrode.

14. The device of claim 12, wherein the drying film is made of a deposition source.

15. The device of claim 14, wherein the deposition source is a desiccant material and is selected from the group consisting of an organometallic complex compound, an alkaline metal compound, an alkaline metal oxide compound, an alkaline earth metal compound, an alkaline earth metal oxide compound, a sulfate compound, a metal halide compound, a perchlorate compound, and an organic compound.

16. A method for manufacturing an organic electroluminescent device, comprising:
providing a substrate;
forming a first electrode on the substrate;
forming an organic functional layer on the first electrode;
forming a second electrode on the organic functional layer;
depositing a drying film over the substrate; and
forming a passivation film over the substrate to form an airtight space, wherein the first electrode, the organic functional layer, the second electrode, and the drying film are encapsulated in the airtight space.

17. The method of claim 16, wherein the drying film is deposited on the second electrode or caps the first electrode, the organic functional layer and the second electrode.

18. The method of claim 16, wherein the drying film is formed with a vapor deposition method.

19. The method of claim 18, wherein the drying film is form with a physical vapor deposition method, a chemical vapor deposition method, or an evaporation method.

20. The method of claim 16, wherein the drying film is made of a deposition source.

21. The method of claim 20, wherein the deposition source is a desiccant material and is selected from the group consisting of an organometallic complex compound, an alkaline metal compound, an alkaline metal oxide compound, an alkaline earth metal compound, an alkaline earth metal oxide compound, a sulfate compound, a metal halide compound, a perchlorate compound, and an organic compound.
